(19) United States
(12) Patent Application Publication
(10) Pub. No.: US 2005/0049130 A1
(43) Pub. Date: Mar. 3, 2005

(54) Printing registration product and method

(76) Inventors: Joseph Kosa, Dayton, NJ (US); Robert Bobkoskie, Hamilton Square, NJ (US); Peter Tindall, Allentown, NJ (US)

Correspondence Address: BUCHANAN INGERSOLL PC, 1835 MARKET STREET, 14TH FLOOR, PHILADELPHIA, PA, 19103-2985, US

(21) Appl. No.: 10/654,206

(22) Filed: Sep. 3, 2003

(51) Int. Cl. B31B 1/88

(52) U.S. Cl. 493/320

(57) ABSTRACT

A method of processing a continuous web of a sheetlike substrate and the resulting article of manufacture are presented. The resulting article comprises multiple layers of the substrate with at least some of the layers decorated with graphical patterns. Outer layers are cut so that they may be lifted, as in opening the pages of a book, thereby revealing graphical patterns on the inner layers. Precise registration of the graphical patterns across these cuts, a necessity for highest visual aesthetic appeal, is achieved by first patterning the substrate and then making the cuts only through the outermost layers. This method of cutting insures that the web as a whole remains intact during processing. The cuts are continuous along essentially the entire length of the web, eliminating waste of material when the web is separated into the individual articles.

### FIELD OF THE INVENTION

This invention relates generally to a perfectly registered substrate product and its novel method of manufacture. Specifically, this invention relates to a novel cutting method used to create advertising, media, and other products made out of different substrate materials that have registered color and graphics, and the resulting products. More specifically, this invention relates to a novel method for processing a continuous web or individual sheets of substrate using “kiss cutting” to generate multiple page advertising brochures, magazine inserts, direct mail pieces, fliers, games, and the like, and the products generated by the method.

### BACKGROUND OF THE INVENTION

Advertising brochures and fliers are well-established media for advertising goods and services. An essential attribute of such media is that it must attract and hold a viewing person's attention. These printed publications must therefore be visually attractive and aesthetically appealing.

One particular type of advertising brochure, sometimes called a gatefold, has one or more pages that can be opened by the viewer, in the manner of book pages, to reveal printed matter inside, previously covered by the pages and therefore unseen. The unopened pages may also have printed matter on their top-side, and a cut, allowing the pages to be opened. To ensure visual attractiveness this top-side printed matter must be properly “registered” on both sides of the cut. Any misalignment or change of color from one side of the cut to the other will detract from the aesthetic appeal of the brochure, thereby diminishing its advertising effectiveness.

A solution to this registration problem is to first complete the printing or other patterning of a substrate material, such as paper, MYLAR®, plastic, plastic film, foil or fabric, and then form the openable pages through a combination of folding the substrate, attaching one segment of the substrate to another segment, and cutting some layers of the substrate, with the cut or cuts slicing through the patterning. If the various pieces of the substrate formed by the cuts cannot move relative to each other after the cuts are made, then the desired registration across the cuts is guaranteed by construction.

Different pieces of the substrate remain fixed relative to each other if the cuts are carefully made only in some layers of the substrate and not in others. One method for accomplishing this is known as “kiss cutting.” In this method, the substrate is configured as a stack of sheets on top of each other, and only the sheet or sheets nearest one side of the stack are cut, leaving other sheets above or below them uncut. This type of cutting can be accomplished, for example, mechanically or optically. Mechanical kiss cutting is done by a die, slitting wheel, knife, or other device or devices with one or more sharp edges. Optical kiss cutting is performed using a laser or other optical device.

Current systems use kiss-cutting in processes for cutting smaller paper or substrate pieces out of larger sections of paper or substrate. For example, European patent EP 0 525 530 B1 to Bootman discloses a method of making perfume-containing pouches for inclusion in magazine advertisements. The individual pouches are separated from a web by kiss-cutting. The pouches can be decorated with artwork designed to match already existing artwork on the magazine page. The kiss-cutting, however, plays no role in this matching other than to define the individual pouches. U.S. Pat. No. 5,953,885 to Berman et al discloses a method of making multiple cosmetic samplers from a web of substrate material. The method involves folding the web and kiss-cutting to define the individual samplers. U.S. Patent Application Publication US 2002/0096241 A1 to Instance discloses a method of producing self-adhesive labels. The labels are separated on a web by cutting only through a top substrate layer, leaving a bottom backing layer uncut.

An object of the present invention is the novel application of kiss-cutting to the mass production of patterned substrates for the purpose of maintaining registration of the pattern across the cut or cuts, as described above. A further object of the present invention is to simplify the separation of the web into the individual products.

Previously known methods of producing such properly registered substrates tend to be more cumbersome, time-consuming, and wasteful of material; hence potentially more expensive. For example, U.S. Pat. Nos. 5,769,773 and 5,938,243 to DeSanto disclose a method for manufacturing advertising brochures from a continuous paper web and the resulting paper products. DeSanto's method provides for cutting the web longitudinally at designated intervals, then folding the web over to create brochures with a continuous back page and a front page with a slit in it, such that consumers may open the brochure to access the advertising material inside. The folding step occurs after the slitting step, which may increase the risk of misaligning the top pages of the resulting product brochures and affect the printing registration.

In addition, this and other existing methods for creating advertising and other media paper products make only intermittent cuts to create the gatefold products, thereby leaving “margins” on the individual products that must be cut off. This adds additional steps and machinery to the methods, increasing manufacturing time and expense. In the DeSanto patents, for example, while the web is still substantially intact, the individual paper products are, by mechanical necessity, joined by uncut strips at the top and bottom, extending across the entire width of the web. In order to complete and properly separate the individual products along the web, these strips must be completely removed; otherwise the pages cannot be opened. This requires at least two carefully positioned transverse cuts by at least two independent knives, and creates wasted substrate material.

By contrast, the kiss cuts of the present invention are made after the folding step, and are therefore more likely to preserve the alignment of the pattern across these cuts. Furthermore, these kiss cuts are continuous along substantially the entire length of the web or individual sheets of substrate, but not through the entire thickness of the substrate. The substrate therefore remains intact without the need for top and bottom margins. The individual products can then be separated with one transverse cut at the top and at the bottom using a single knife or other cutting device—according to this embodiment of the present invention, the process is simplified and the amount of wasted substrate material is reduced. Alternatively, two or more knives can be used if additional material must be removed between each product, or at the top and/or bottom of each product, in order to meet customer demands.

### SUMMARY

The present invention provides a novel method of manufacturing advertising brochures, magazine inserts, and other related paper products from a continuous web, or one or more individual sheets of substrate, using kiss-cutting to create multiple advertising or printed surfaces. The method eliminates the problem of imperfect registration, thereby providing a product with the highest standard of printing quality for advertising, marketing, direct mail, and other printed materials.

According to one aspect of the present invention, a continuous web or one or more individual sheets of substrate is printed, on one or both sides. The substrate is any material capable of receiving and retaining print, and the print can be either in color or black and white or a combination thereof. Substrates according to the present invention include paper, MYLAR®, plastic, plastic film, fabric, and metal foils. The substrate is also optionally coated with one or more coatings, including but not limited to fragrances, including fragrance oils, varnish, latex, including latex “scratch-off” materials, sublimation and other inks, and cosmetics, such as eye shadow, blush, lip gloss, lipstick, etc. It will be obvious to one of skill in the art that many types of substrates can be printed upon and are therefore contemplated by the present invention and many different coatings can be applied to various substrates, such that the present invention is therefore not limited to the previous lists.

The substrate, whether in continuous web or individual sheet form, is mechanically displaced in one or more places to create two or multiple layers, the layers sitting on top of one bottom layer. Mechanical displacement can be folding, ribboning, or any other method of displacing a segment of the substrate to create two or more layers. One or several of the top layer(s) of the substrate is then longitudinally “kiss cut” in the same direction that the substrate is traveling as it is being processed. As many layers as are required are cut through, leaving at least the bottom layer uncut. The process can be adjusted so that the required number of layers are “kiss cut” according to customer specifications for the final desired substrate product. Mechanical displacement can occur before or after any desired coatings are applied to the substrate.

Importantly, the “kiss cut” method slits at least one layer of substrate after the substrate has been printed upon and after the paper has been displaced into the required format for the final product. According to an alternative embodiment, additional mechanical displacement of one or more segments of the substrate may occur after the substrate has been kiss cut. The “kiss cut” advantageously provides perfect or near-perfect registration of printing color and graphics.

According to an aspect of the present invention, “kiss cutting” occurs by mechanical or optical cutting. Mechanical cutting can occur by a die, slitting wheel, knife, or other mechanical cutting method known to those of skill in the art. Optical cutting can occur by laser or other optical cutting method known to those of skill in the art.

The longitudinal “kiss cut” extends substantially continuously throughout the entire length of the substrate. After the substrate is “kiss cut”, when the substrate is in the form of a continuous web, it can be optionally further processed by transversely cutting the web into individual products at designated intervals. Importantly, each resulting product is free from any “extra” segment or margin due to the fact that the longitudinal “kiss cut” extends substantially the entire length of the web. Thus, the individual products have freely openable segments that provide additional advertising space, and that are created immediately upon transversely cutting the web into individual products without the need to further remove any “extra” segments or margins. Only one transverse cutting device is required to separate the individual products from each other but more than one transverse cutting device can be used.

According to an alternative embodiment, segments of substrate are removed from one or both ends of each individual product, in order to meet customer specifications, for example, to maintain uncommon bleed color at opposite ends of each product, or to create a particular sized product. In those instances, more than one transverse cutting knife or other device can be used to remove the necessary segment or segments from the individual products.

### BRIEF DESCRIPTION OF DRAWINGS

FIG. 1 depicts the continuous process of the present invention performed on a web of substrate to generate a single gatefold product.

FIG. 2 depicts the continuous process performed on a web of substrate to generate a double gatefold product.

FIG. 3 depicts the continuous process performed on a web of substrate to generate a ribboned kiss cut product.

FIGS. 4A and 4B provide an example of a single gatefold product generated by the claimed method.

FIGS. 5A and 5B provide an example of a double gatefold product generated by the claimed method.

FIG. 6 depicts a flow chart of steps of the present invention using individual sheets of substrate to create a single gatefold product.

FIG. 7 depicts a flow chart of steps of the present invention using individual sheets of substrate to create a double gatefold product.

### DETAILED DESCRIPTION OF THE INVENTION

The product of the present method is generated by the novel “kiss cut” method of the present invention. Frequently, the resulting kiss cut product is an advertising brochure, magazine insert, or other media/informational paper product. Customers requiring improved registration of printing and graphics on their products will select the product and method of the present invention over others that do not provide sufficient registration.

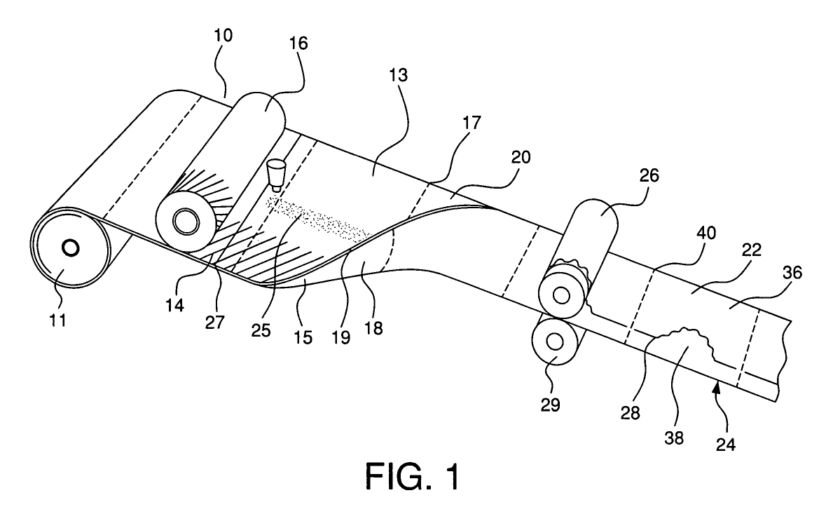

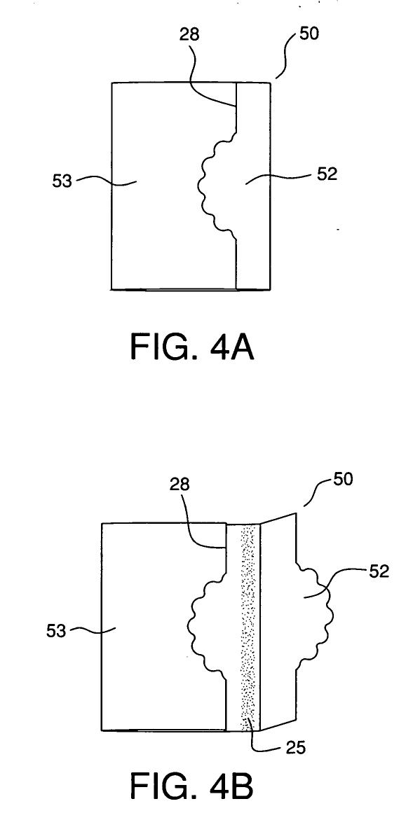

FIG. 1 illustrates one embodiment of the present invention, using a continuous web 10 of substrate to generate a kiss cut, single gatefold product 50, which product is illustrated on FIGS. 4A and 4B. It is to be understood that the embodiment illustrated in FIG. 1 and described in the following paragraphs is but one possible embodiment of the invention and is not to be regarded as limiting.

Referring to FIG. 1, the substrate issues as a web 10 from a roll 11. The substrate has graphic areas such as text and/or illustrations, on one or both of the top side 13 and bottom side 15, respectively, of the web 10. These graphic areas repeat periodically along substantially the entire length of the web 10 and are created in a pattern-generating process such as printing.

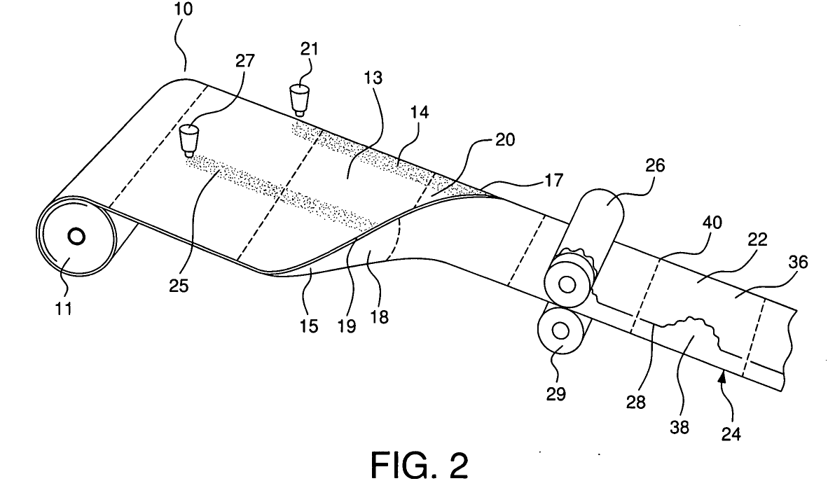

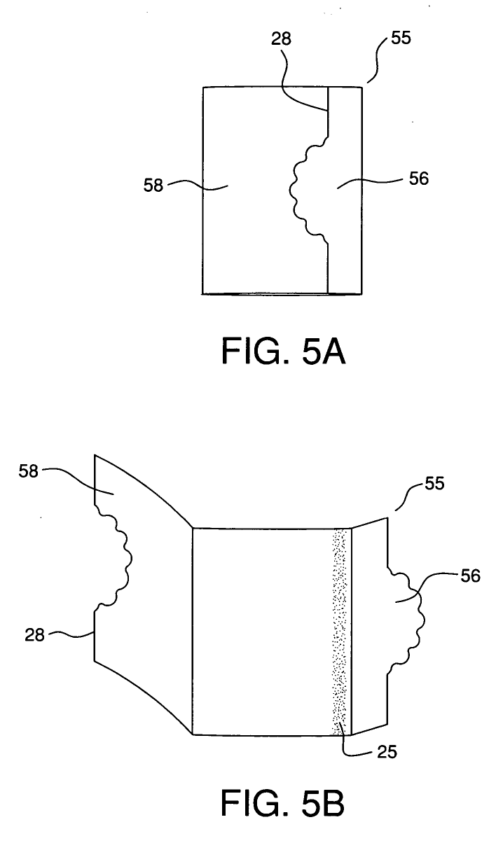

Referring to FIG. 1, areas of adhesive 14 (indicated by shading) are applied to the substrate by a roller 16. These areas of adhesive may be spots, lines, or large areas depending on the nature of the final product. The roller 16 for application of adhesive is only one example of a device contemplated by the present invention for dispensing adhesive. It will be understood by one ordinarily skilled in the art that other devices that dispense adhesive in the necessary quantity and location on the substrate fall within the scope of this invention. Another embodiment, for example, is illustrated on FIG. 2, which illustrates using a continuous web 10 of substrate to generate kiss cut, double gate fold products 55, which products are illustrated in FIGS. 5A and 5B. As shown on FIG. 2, areas of adhesive 14 are dispensed onto one edge of the top side 13 of the substrate using a tubular dispenser 21.

As illustrated on both FIGS. 1 and 2, a segment 18 of the web 10 is displaced transversely and attached to an undisplaced segment 20. The displaced segment 18 is secured to the undisplaced segment 20 by means of the areas of adhesive 14. Once secure in this manner, the two segments may be regarded as a top layer, 22, and a bottom layer, 24, the displaced segment 18 being joined with at least one other point on the top side 13 of the substrate. FIG. 1, for example, illustrates joining the displaced segment 18 with the top side 13 over a broad area, as indicated by the use of a wide swath of adhesive 14 on the top side 13. FIG. 2, on the other hand, illustrates joining the displaced segment 18 at only a small portion of the top side 13 near one edge 17 such that the edges 17 and 19 of the substrate are joined, as indicated by the use of a smaller swath of adhesive 14 on the substrate.

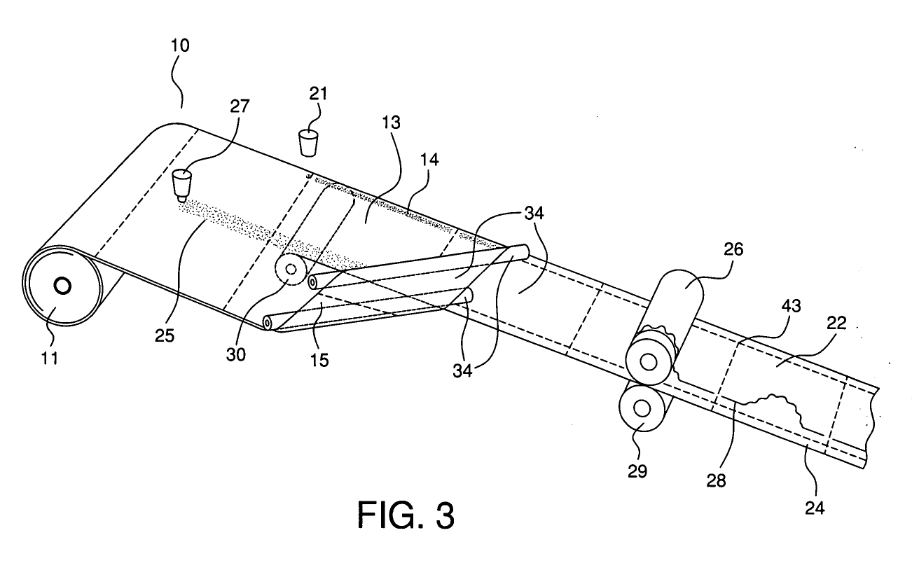

Displacement of the substrate occurs mechanically, and the displacement may be in the form of a single fold, as illustrated in FIGS. 1 and 2, or a “ribbon” of the substrate, as illustrated in FIG. 3. It will be understood by those ordinarily skilled in the art that mechanical displacement of a web or individual sheets of substrate according to the present invention is not limited to the examples set forth herein, and that the mechanical displacement is carried out by any mechanical device suited to displace the substrate.

For example, as shown in FIG. 3, a cutting device 30 continuously cuts the substrate, which subsequently is ribboned using bars 32 that roll the substrate over at least one time to bring the ribboned, displaced segment 34 of the web 10 onto the top side 13 of the substrate. The ribboning cut is performed at any point between the two edges 17 and 19 of the substrate such that the ribboned, displaced segment 34, which is comprised of one or more segments of substrate, according to this embodiment can be smaller than the top side 13 of the substrate.

Referring back to FIGS. 1 and 2, the next step in the process is the selective cutting of the substrate layers, sometimes called a “kiss cut.” In the embodiment illustrated here a cutting device 26 cuts through only the top layer 22, leaving the bottom layer 24 uncut and fully intact. It is to be understood that the invention is not limited by the number of layers, and that the kiss cut can be made through any number of layers, starting with a layer either on the top side 13 or bottom side 15 of the web 10. The resulting cut 28 is made continuously through the length of the substrate, in this case, a continuous web. The transverse dotted lines on FIGS. 1 and 2 illustrate the potential size of the final individual products generated according to the present method, such as brochures or other advertising media, however, the resulting cut 28 completely spans the length of each product.

In the embodiments illustrated in FIGS. 1 and 2, the cutting device 26 is shown as a die, however it is to be understood that the cutting device 26 is not limited to a die and may also be a rotary cutter, a knife, or an optical cutting device such as a laser. Further, more than one cutting device 26 is contemplated in the current invention, for example, two or more knives in tandem may be used to create the continuous longitudinal slit 28 and two or more cutting devices can be used to create multiple longitudinal slits. An advantage to the use of a cutting die or laser is that the cut may be given an arbitrary shape, thereby allowing a greater variety in the possible forms of the final product. Since the kiss cut or cuts are made only after the substrate has been printed upon, precise registration of the patterns on the left side 36 and the right side 38 of each cut 28 is guaranteed by construction. A support bar, roller or other device 29 is optimally located beneath the web 10 at the location where the web 10 is longitudinally cut, to prevent buckling of the web 10 during this step.

Referring to FIG. 3, the kiss cut for the ribboned web is performed using a cutting device 26 such as the die shown in FIG. 3, and the ribboned, displaced segment 34 is kiss cut, leaving the bottom layer 24 uncut. This enables the design of products different from those illustrated in FIGS. 4A, 4B, 5A, and 5B, that can have multiple gatefolds at different locations, for added flexibility and creativity in advertising and media.

Referring now to FIGS. 1, 2, and 3, one or more coatings 25 are optionally applied to the substrate, such as fragrance, latex, varnish, ink, and/or cosmetic products, using an applicator 27. Ink coatings include various types of ink, such as sublimation, or tattoo ink. Cosmetic products include a wide variety of products such as, but not limited to, eye shadow, eye liner, lip gloss, lipstick, blush, and concealer. The coatings 25 are applied to the substrate in the form of compositions, which are made up of the coatings alone or the coatings subsumed in a binder or other mixture, as necessary for the application of the coatings. For example, fragrance may be applied to the substrate in the form of an oil, to market the fragrance to consumers. Different types of compositions as required for the application of various coatings will be understood by those of ordinary skill in the art to be part of this invention.

The coating applicator 27 contemplated by the current invention is any type of application device that will apply the required amount of coating(s) to the substrate, depending on the type of substrate and quantity of coating necessary to meet customer specifications. It will be understood by those skilled in the art that the applicator 27 is not limited to the “bottle” or “tube” example depicted in FIGS. 1, 2, and 3.

Referring to any of FIGS. 1, 2, or 3, the web 10 can be separated into the individual products. According to this embodiment, a series of single transverse cuts 40 are made through the top layer 22 and the bottom layer 24, extending completely across the width of the web 10. These cuts 40 can be made at any location along the web 10, based on the desired final product. The transverse dotted lines which indicate locations of transverse cuts 40 are exemplary only and do not limit the size or shape of the final product contemplated by the current invention. These cuts 40 are generally made with the same periodicity as that of the graphic patterns printed on the substrate, thus producing a plurality of identical products. In this embodiment these transverse cuts 40 are made by a cutting device such as a die, slitting wheel, knife, or optical cutting device such as a laser. More than one cutting device used in tandem is also contemplated by the current invention. Additionally, this separation of the web 10 need not occur as part of the process illustrated here. Instead, following the kiss cut the processed web may be collected in some manner, such as a roll, and shipped elsewhere for separation.

FIGS. 4A and 4B illustrate one example of a final product contemplated by the present invention, a single gatefold product 50. The right side of the brochure is a single openable page 52, formed by the kiss cut according to the method of the present invention, and is shown in a closed position in FIG. 4A and an open position in FIG. 4B. A coating composition 25, such as fragrance, which was applied according to the method of the present invention as indicated in FIG. 1, is present under the single openable page 52.

FIGS. 5A and 5B illustrate another example of a final product contemplated by the present invention, a double gatefold product 55. The two openable pages, 56 and 58, are formed by the kiss cut according to the method of the present invention. FIG. 5A shows the pages 56 and 58 in their closed position, separated by the kiss cut 28 running the entire length of the brochure 55. FIG. 5B shows the pages in their open position. A coating composition 25 lies under the right page 56, applied during the method of the present invention as indicated in FIG. 2.

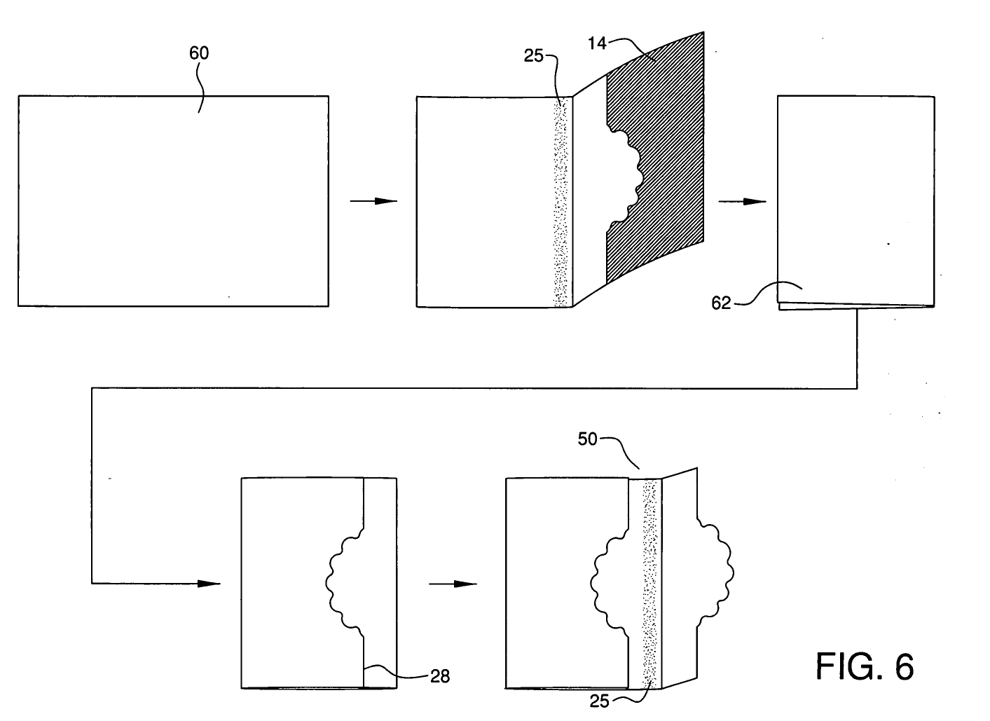

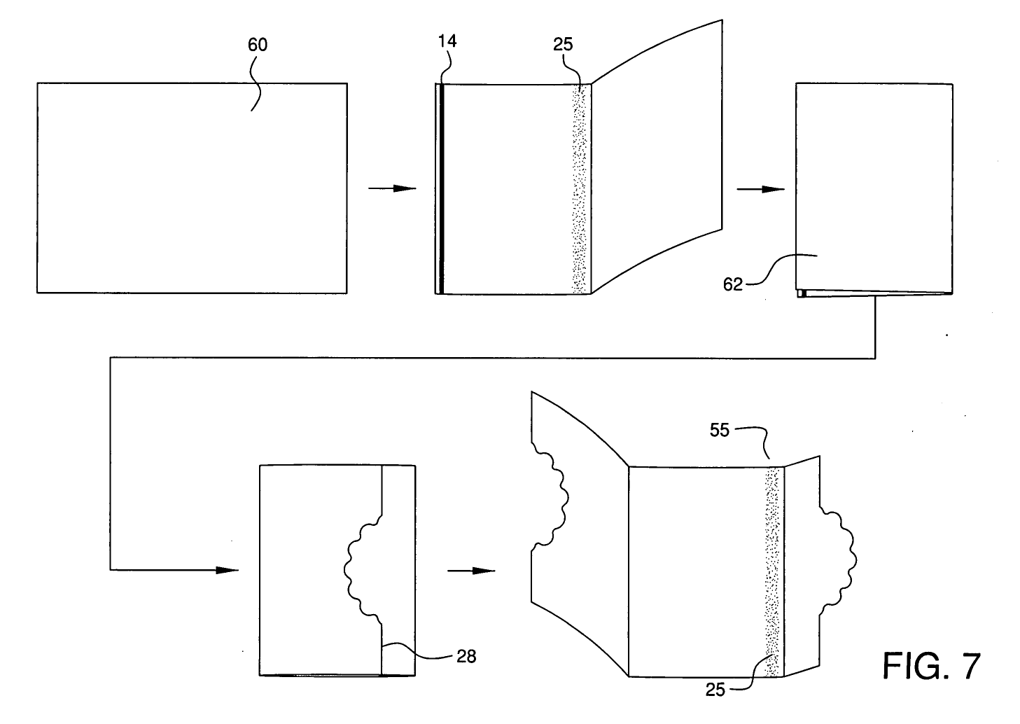

The present invention also contemplates processing individual sheets of substrate, as illustrated in FIGS. 6 and 7. These figures provide flow diagrams for processing individual sheets 60 of substrate. According to the present invention, sheets 60 of substrate are continuously processed in the same manner as the web 10 in FIGS. 1, 2 and 3, but without the need for tranverse cuts to separate the finished products.

As shown in FIGS. 6 and 7, areas of adhesive 14 and optionally a coating composition 25 is applied to each individual sheet 60 of substrate, which has been printed with graphic areas such as text and/or illustrations, on one or both of the top and bottom sides of each sheet 60. Each sheet is then mechanically displaced, such as by folding 62, and kiss cut 28 to generate a single 50 or double 55 gatefold product.

The foregoing illustrations of embodiments of the present invention are offered for the purposes of illustration and not limitation. It will be readily apparent to those skilled in the art that the embodiments described herein may be modified or revised in various ways without departing from the spirit and scope of the invention. The scope of the invention is to be measured by the appended claims.

1. A method for processing a continuous web of substrate, said substrate having a top side and a bottom side, said method comprising the steps of:
(a) printing graphic areas on one or both of said top and bottom sides, said graphic areas repeating periodically along the longitudinal direction of the web;
(b) mechanically displacing the web to transversely bring a segment of said web into contact with said top side and secure said segment to said top side, thereby creating at least one top layer and a bottom layer, and binding said layers; and
(c) longitudinally cutting at least one longitudinal slit through:
at least one of said at least one top layer, thereby leaving said bottom layer if said longitudinal slit is made from the top side of said substrate, or
at least said bottom layer if said longitudinal slit is made from the bottom side of the substrate,
said at least one longitudinal slit extending essentially the entire length of the web in the longitudinal direction, and thereby leaving the printing and colors of said graphic areas registered on both sides of each said longitudinal slit, said longitudinal slit lying at a point between the two edges of said substrate.

2. The method of claim 1 further comprising the step of:
(d) cutting a periodically repeating series of transverse slits through said at least one top layer and said bottom layer, said transverse slits extending from one edge of said substrate to the other, and dividing the substrate into individual articles, said substrate being divided by said at least one longitudinal slit into at least two openable flaps on the top side or the bottom side based on the location of the longitudinal slit.

3. The method of claim 1 wherein said mechanical displacement comprises folding.

4. The method of claim 1 wherein said mechanical displacement comprises ribboning.

5. The method of claim 1 further comprising applying at least one composition to said substrate, said composition comprising at least one product selected from the group consisting of fragrance, latex, varnish, ink and cosmetic products.

6. The method of claim 5 wherein said composition is applied before said displacing step.

7. The method of claim 1, further comprising the step of embossing said substrate.

8. The method of claim 1 in which said longitudinal cutting comprises mechanical cutting.

9. The method of claim 8 wherein said mechanical cutting comprises cutting by at least one die.

10. The method of claim 8 wherein said mechanical cutting comprises cutting by at least one knife.

11. The method of claim 8 wherein said mechanical cutting comprises cutting by at least one slitting wheel.

12. The method of claim 1 in which said longitudinal cutting comprises optical cutting.

13. The method of claim 12 wherein said optical cutting comprises cutting by a laser.

14. The method of claim 1 wherein said at least one longitudinal slit has a curvilinear shape.

15. The method of claim 1 wherein said binding comprises gluing.

16. The method of claim 1 wherein said substrate comprises at least one printable material selected from the group consisting of paper, MYLAR®, plastic, plastic film, foil, and fabric.

17. A method for processing at least one sheet of substrate, each of said at least one sheet having a top side and a bottom side, said method comprising the steps of:
(a) Printing graphic areas on one or both of said top and bottom sides of each sheet;
(b) mechanically displacing a portion of each of said at least one sheet to transversely bring said portion of said at least one sheet into contact with said top side and secure said portion to said top side, thereby creating at least one top layer and a bottom layer, and binding said layers; and
(c) longitudinally cutting at least one longitudinal slit through
said at least one top layer, thereby leaving said bottom layer intact if said longitudinal slit is made from the top side of said sheet, or
at least said bottom layer if said longitudinal slit is made from the bottom side of said sheet,
said at least one longitudinal slit extending essentially the entire length of the at least one sheet in the longitudinal direction, and thereby leaving the printing and colors of said graphic areas registered on both sides of each said longitudinal slit, said longitudinal slit lying at a point between the two edges of said sheet.

18. The method of claim 17 wherein said displaced portion of said at least one sheet comprises part or whole single sheet of substrate.

19. The method of claim 17 wherein said mechanical displacement comprises folding.

20. The method of claim 17 wherein said mechanical displacement comprises ribboning.

21. The method of claim 17 further comprising applying at least one composition to said substrate, said composition comprising at least one product selected from the group consisting of fragrance, latex, varnish, ink and cosmetic products.

22. The method of claim 21 wherein said composition is applied before said displacing step.

23. The method of claim 17, further comprising the step of embossing said at least one sheet of substrate.

24. The method of claim 17 in which said longitudinal cutting comprises mechanical cutting.

25. The method of claim 24 wherein said mechanical cutting comprises cutting by at least one die.

26. The method of claim 24 wherein said mechanical cutting comprises cutting by at least one knife.

27. The method of claim 24 wherein said mechanical cutting comprises cutting by at least one slitting wheel.

28. The method of claim 17 in which said longitudinal cutting comprises optical cutting.

29. The method of claim 28 wherein said optical cutting comprises cutting by at least one laser.

30. The method of claim 17 wherein said at least one longitudinal slit has a curvilinear shape.

31. The method of claim 17 wherein said binding comprises gluing.

32. The method of claim 17 wherein said substrate comprises at least one printable material selected from the group consisting of paper, MYLAR®, plastic, plastic film, foil, and fabric.

33. An article of manufacture fabricated from a substrate, said substrate comprising a continuous web or at least one sheet, said substrate having a top side and a bottom side, and said article being fabricated by a process comprising the steps of:
(a) printing graphic areas on one or both sides of the substrate, said graphic areas repeating periodically along the longitudinal direction of the substrate;
(b) mechanically displacing said substrate to transversely bring a segment of said substrate into contact with said top side and securing said segment to said top side, thereby creating at least one top layer and a bottom layer, and binding said layers; and
(c) creating at least one longitudinal slit through
at least one of said at least one top layer, thereby leaving said bottom layer intact if said longitudinal slit is made from the top side of said substrate, or
at least said bottom layer if said longitudinal slit is made from the bottom side of said substrate,
said at least one longitudinal slit extending essentially the entire length of the substrate in the longitudinal direction, and thereby leaving the printing and colors of said graphic areas registered on both sides of each said longitudinal slit.

34. The article of claim 33 wherein said process further comprises the step of:
(d) cutting a periodically repeating series of transverse slits through both said at least one top layer and said bottom layer, said transverse slits extending from said one edge of said layers to the other, and dividing the substrate into individual articles, said substrate being divided by said at least one longitudinal slit into at least two openable flaps on the top side or the bottom side based on the location of the longitudinal slit.

35. The article of claim 33 in which said cutting comprises mechanical cutting.

36. The article of claim 35 wherein said mechanical cutting comprises cutting by at least one die.

37. The article of claim 35 wherein said mechanical cutting comprises cutting by at least one knife.

38. The article of claim 35 wherein said mechanical cutting comprises cutting by at least one slitting wheel.

39. The article of claim 33 in which said cutting comprises optical cutting.

40. The article of claim 39 wherein said optical cutting comprises cutting by at least one laser.

41. The article of claim 33 in which said at least one longitudinal slit has a curvilinear shape.

42. The article of claim 33 wherein said process further comprises the step of applying a composition to said substrate, said composition comprising at least one product selected from the group consisting of fragrance, latex, varnish, ink and cosmetic products.

43. The article of claim 42 wherein said composition is applied before said displacing step.

44. The article of claim 33, wherein said process further comprises the step of embossing said substrate.

45. The article of claim 33 wherein said binding comprises gluing.

46. The article of claim 33 wherein said article comprises an advertising flier, magazine insert, direct mail piece, point of purchase, and game.

47. The article of claim 33 wherein said substrate comprises at least one printable material selected from the group consisting of paper, MYLAR®, plastic, plastic film, foil, and fabric.
